(19) United States
(12) Patent Application Publication
(10) Pub. No.: US 2014/0227096 A1
(43) Pub. Date: Aug. 14, 2014

(54) FLOATING SUPPORT PLATFORM FOR WIND TURBINE

(71) Applicant: Mirko Montalti, (US)

(72) Inventor: Mirko Montalti, Mercato Saraceno (IT)

(21) Appl. No.: 14/347,206

(22) PCT Filed: Sep. 26, 2012
(86) PCT No.: PCT/EP2012/068906

§ 371 Date: Mar. 25, 2014

(30) Foreign Application Priority Data
Sep. 29, 2011 (IT) GE2011A000108

(51) Int. Cl. F03D 11/04

(52) U.S. Cl. CPC F03D 11/045
USPC 416/85

(57) ABSTRACT

Support platform for wind generators, comprising a central body (5) provided with a seat engaging with a final section (4) of a pillar (1) of a wind generator (2); this central body (5) is connected by means of a series of radial elements (6) to an annular floating structure (7) and provided internally with position-adjusting means (10) cooperating on the one hand with the base of this final section (4) of the pillar (1) and on the other hand with suitable support elements (9), these position-adjusting means (10) being able to receive and contain a given quantity of fluid and vary the height of the wind generator (2) by means of the raising or lowering of said pillar (1).

### CROSS REFERENCE TO RELATED APPLICATIONS

The present application claims priority to Italian Patent Application No. GE2011A000108 filed Sep. 29, 2011 and International Application No. PCT/EP2012/068906 filed Sep. 26, 2012, the contents of which are expressly incorporated herein by reference.

### STATEMENT RE: FEDERALLY SPONSORED RESEARCH/DEVELOPMENT

Not Applicable.

### BACKGROUND OF THE INVENTION

The present invention relates to a floating support platform for wind generators.

As is known, systems for generating electric power based on the use of wind generators or wind towers are known. These systems generally comprise a vertical pillar of a certain height which supports a wind generator turbine comprising a certain number of blades rotating about a horizontal axis or, in some cases, vertical axis. These wind towers, in order to perform efficiently, must be situated in zones where the wind blows with a certain strength and where they will not create problems in terms of their visual impact on the surrounding landscape. At present research is being conducted into systems for supporting wind towers which allow them to be arranged out at sea where the wind often blows more strongly than on dry land and where they do not pose landscape-related problems. These supports envisage floating systems on which the wind towers are fixed. These systems are very bulky and are difficult to construct as well as having various limitations in terms of safety and efficiency; in fact, being floating systems, it should be possible to vary their position depending on the sea and wind conditions.

### SUMMARY OF THE INVENTION

The object of the present invention is therefore to provide a support platform for wind towers which, by means of the use of suitable variable-position floating means, is able to ensure always an optimum efficiency and maximum safety even in particularly strong wind conditions or rough sea conditions.

This object is achieved with the present invention by means of a floating support platform for wind generators according to claim 1.

Other innovative features of the present platform form the subject of the dependent claims.

### BRIEF DESCRIPTION OF THE DRAWINGS

Further characteristic features and advantages of the present invention will be understood more clearly from the following description provided by way of a non-limiting example with reference to the accompanying drawings in which:

FIG. 1 shows a side elevation view of a wind tower provided with a floating support platform according to the present invention;

FIG. 2 shows a partially sectioned and partial side elevation view of the support platform provided internally with a membrane tank in a rest position;

FIG. 3 shows a partially sectioned plan view of the present support platform;

FIG. 4 shows a partially sectioned plan view of a part of the support platform provided with means for preventing undesirable rotation about the vertical axis of the wind tower;

FIG. 5 shows a partially sectioned and partial side elevation view of the support platform where the membrane tank is in the compressed position;

FIG. 6 shows a partially sectioned, side elevation view of the support platform where the membrane tank is in the expanded position; and

FIG. 7 is a schematic stability diagram which shows along the x-axis the inclination of the wind tower in degrees [°] with respect to a vertical axis and along the y-axis the righting moments and tilting moments [t*m].

### DETAILED DESCRIPTION OF THE INVENTION

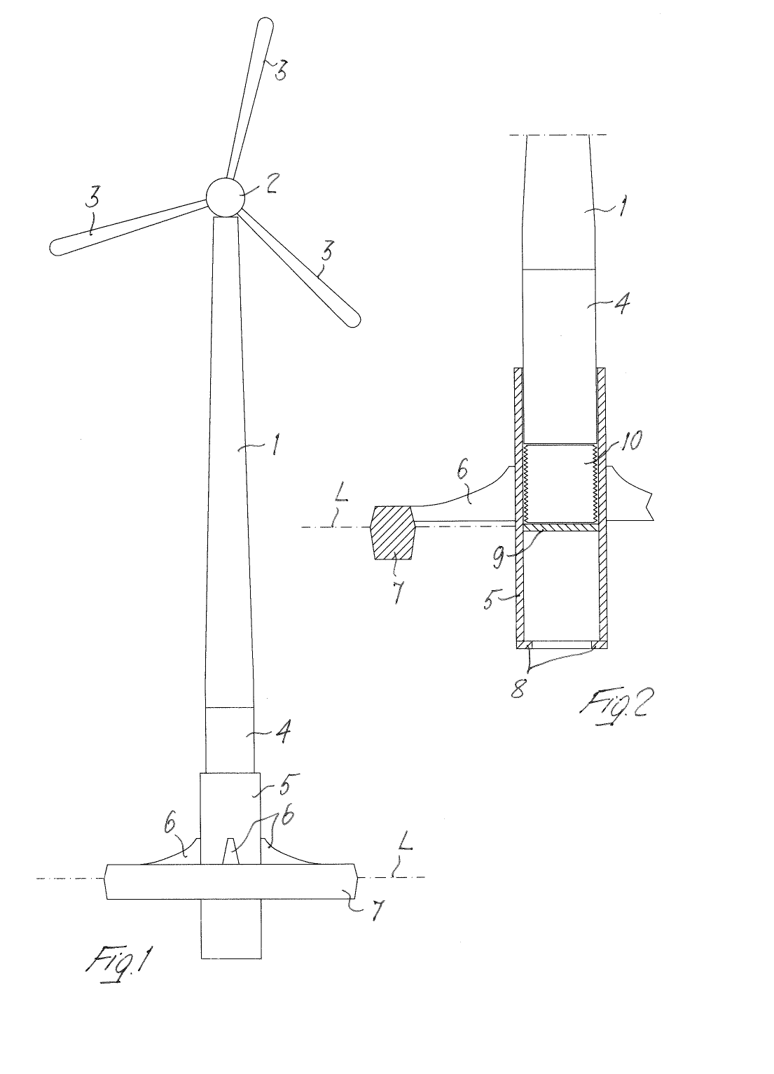

With reference to these accompanying drawings and with particular reference to FIG. 1 thereof, 1 denotes the vertical pillar of a turbine wind generator or wind tower 2 comprising a series of blades 3. This pillar 1 of the wind generator 2 comprises at the bottom a cylindrical section 4 engaging inside a cylindrical central body 5 of a support platform according to the present invention. This cylindrical central body 5 is connected by means of a series of radial elements 6 to a ring 7 which surrounds this cylindrical central body 5 and is designed to float in a water basin, for example the sea or a lake. As can be noted, this cylindrical central body 5 extends beyond the heightwise position of the ring 7 situated at the floating level L.

The cylindrical central body 5 is open both at the top end (see FIG. 2) for engagement of the final section 4 of the wind tower and at the bottom end, where it comprises an annular plate 8. A rigid disc 9 for supporting a membrane tank 10 containing, for example, compressed air and able to be compressed or expanded so as to move the pillar 1 of the wind tower downwards or upwards is positioned at a certain height of the cylindrical body 5. The rigid disc 9 is fixed to the membrane tank and may be positioned at various heights by means of suitable locking pins, not shown, along the central cylindrical body 5 of the platform. The bottom limit position of this rigid disc 9 is represented by the annular plate 8 against which this disc 9 rests. The floating ring 7 may be formed with a vertical cross-section of any desired shape; in this case the shape of the cross-section of this ring is hexagonal, but it could also be pentagonal, circular or another shape. In this first side view shown in FIG. 2 the membrane tank 10 is shown in a first condition where it is in an intermediate, normal working position. The wind tower 2 is in this case situated at the top dead-centre position and the pillar 1 is rigidly connected to the platform and supported by means for performing locking to the central cylindrical body 5. In this situation this membrane tank 10 is partially filled with air and remains in a rest position.

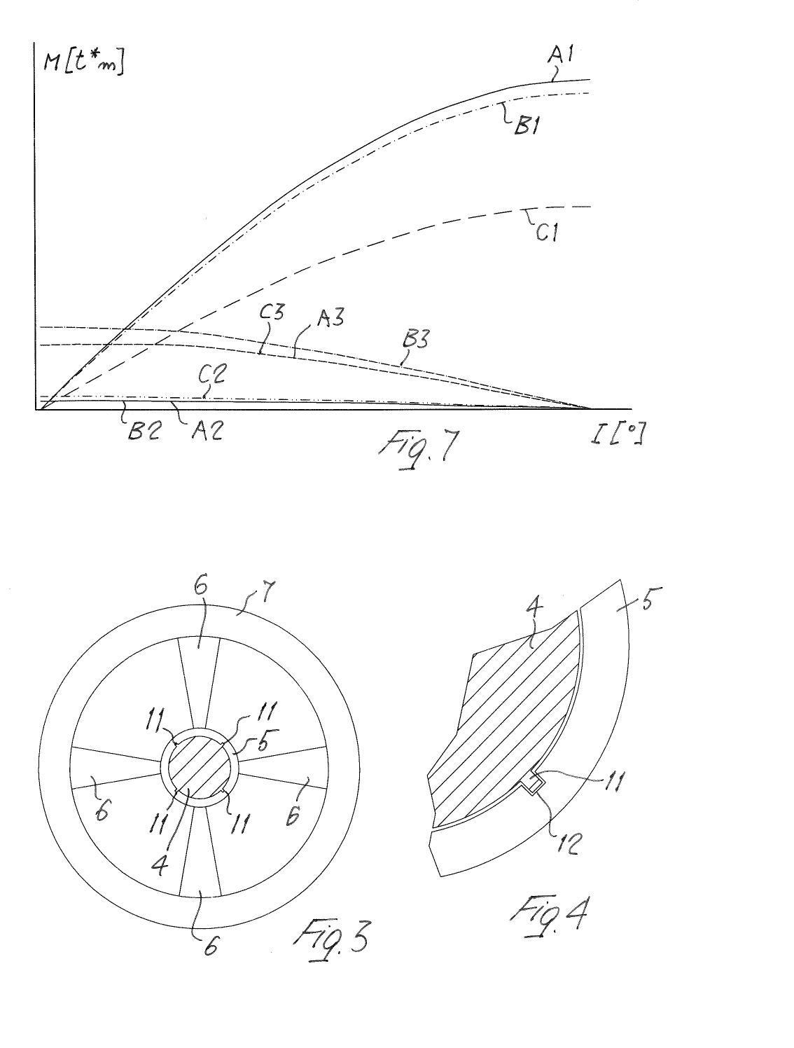

FIG. 3 shows a plan view of the present floating platform for supporting a wind tower. The floating ring 7 has a substantially circular shape, while the radial elements 6 which connect the cylindrical central body 5 to this floating ring 7 have the same length and are equidistant from each other. These radial elements 6 may consist of any number depending on the different application situations of the platform. As mentioned, the pillar of the wind tower may slide vertically upwards or downwards and the final section 4 for engagement in the central cylindrical body 5 is provided with suitable projecting ribs 11 (see also the enlarged view of FIG. 4) designed to engage inside corresponding vertical grooves 12 formed in the inner surface of the cylindrical central body 5. These ribs 11 housed inside these grooves 12 prevent any rotation of the pillar 1 of the wind tower with respect to the vertical axis along which this pillar 1 extends and the cylindrical section 4 engaging inside the cylindrical central body of the platform.

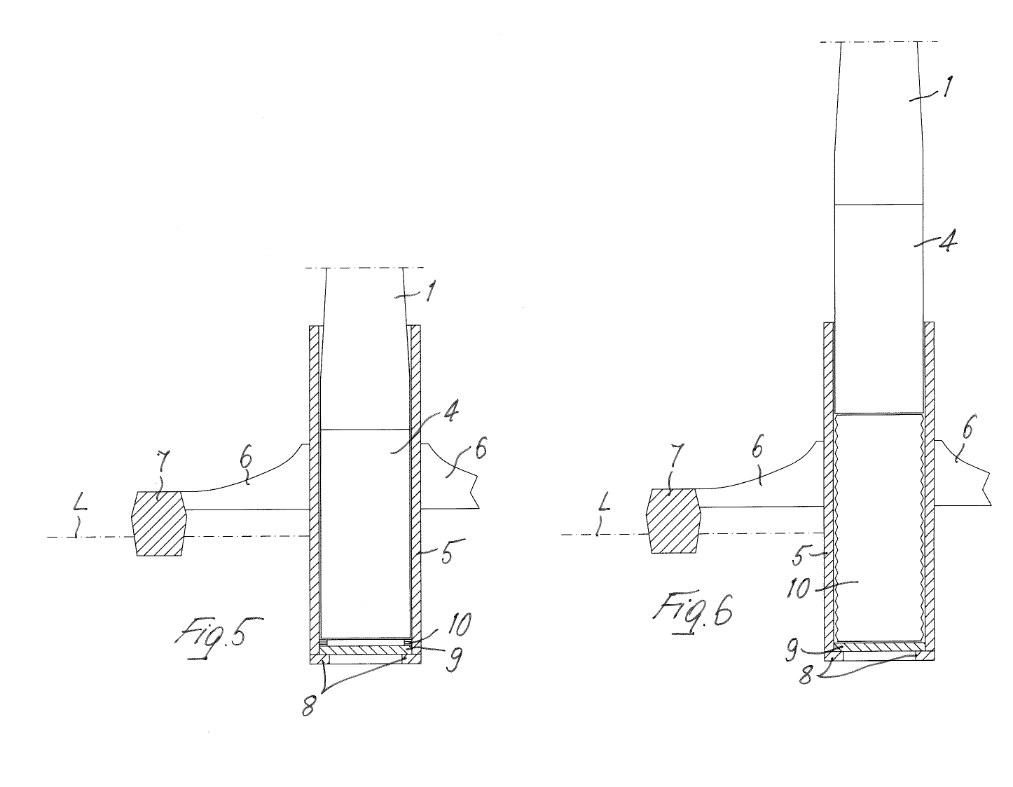

FIG. 5 shows a second condition of the present platform where the membrane tank 10 is completely deflated and the associated rigid support disc 9 bears against the annular plate 8 (cf. FIGS. 1 and 5 in this connection). This condition corresponds to a position of the wind tower completely lowered to the bottom dead-centre position, which may be used in those cases where maximum safety is required. This condition may be used during operation of the wind tower also in particularly strong wind conditions.

FIG. 6 shows a third condition of the present platform where the membrane tank 10 is completely inflated and expanded, while the associated support disc 9 is situated still bearing against the annular plate 8 situated at the bottom end of the cylindrical central body 5. This completely raised position of the wind tower is transitory and is used for installation of the tower, which is situated in the top dead-centre position owing to the raising action provided precisely by inflation of the membrane tank 10.

FIG. 7 is a schematic diagram showing the progression of the righting and tilting moments [t*m] as a function of the inclination in degrees [°] of the wind tower. A nominal wind speed of 11.2 m/s and maximum wind speed of 27.8 m/s were considered in order to calculate the curves in this diagram. These curves refer to the three positions or conditions described above and therefore in the case of the platform situated in the first position or condition shown in FIG. 2, A1 is the curve for the righting moment, A2 is the nominal tilting moment and A3 is the maximum tilting moment. In the case of the platform in the second condition shown in FIG. 5, B1 is the righting moment, B2 is the nominal tilting moment and B3 is the maximum tilting movement, while in the case of the platform in the third condition shown in FIG. 6, C1 is the righting moment, C2 is the nominal tilting moment C2 and C3 is the maximum tilting moment.

In addition to that illustrated and described, the present platform will be provided with reinforced points for anchoring, winching and haulage using hoisting means, for example a crane, also under full load conditions, i.e. when completely fitted out. At least one of the radial elements 6 for connecting the cylindrical central body 5 to the floating ring 7 may be provided with a gangway for allowing access by workmen. Safety means for transit on-board the platform will also be provided, such as a handrail, life-line or the like, and the floating ring must have a mooring point for a vessel. The tower must moreover be provided with a system suitable for providing the membrane tank 10 with the necessary compressed air for the pneumatic raising and lowering movements of the wind tower.

Floating of the present platform is ensured by the keel formed by the ring 7 together with the effect provided by the wind tower in the bottom dead-centre position, shown in FIG. 5, or by the completely expanded membrane in the position shown in FIG. 6, without varying immersion of the system; in the position shown in FIG. 2 floating is ensured exclusively by the platform with a suitable variation of the immersion. During normal operation of the wind generator 2 it is envisaged that the floating platform is exposed, as mentioned, to an average wind speed of about 11.2 m/s which produces a tilting moment able to keep the system banked by about 2°. The tower and platform system may, as mentioned, be exposed to a maximum wind speed condition of 27.8 m/s. The present platform will also be provided with an automation system which will have the task, not only of monitoring and managing normal operation of the system, but also of modifying the position of the wind tower and the platform from one position to another from among those described above, for example from a normal operating position shown in FIG. 2 to a safety position shown in FIG. 5 in the case where the wind strength and/or climatic/sea conditions exceed predetermined safety values. This position adjustment results in a reduction in the area exposed to the wind and therefore a reduction of the tilting moment and a reduction in the height of the centre of gravity of the tower and platform system, thereby ensuring a better overall stability.

What is claimed is:

1. Support platform for wind generators, characterized in that it comprises a central body (5) provided with a seat engaging with a final section (4) of a pillar (1) of a wind generator (2), said central body (5) being connected by means of a series of radial elements (6) to an annular floating structure (7) and provided internally with position-adjusting means (10) cooperating on the one hand with the base of said final section (4) of the pillar (1) and on the other hand with suitable support elements (9), said position-adjusting means (10) being able to receive and contain a given quantity of fluid and vary the height of the wind generator (2) by means of the raising or lowering of said pillar (1).

2. Platform according to claim 1, characterized in that said position-adjusting means comprise at least one membrane tank (10) situated inside the central body (5) and designed to be inflated and deflated so as to raise or lower the pillar (1) of the wind generator (2).

3. Platform according to claim 2, characterized in that said membrane tank (10) is connected to a compressed-air supply source for inflation and deflation thereof.

4. Platform according to claim 1, characterized in that said central body (5) is cylindrical and internally hollow and comprises in the vicinity of the bottom end an annular element (8) supporting the said position-adjusting means (10).

5. Platform according to claim 2, characterized in that said membrane tank (10) assumes at least a normal operating condition where it is partially filled with fluid and the wind generator (2) is at an intermediate height.

6. Platform according to claim 2, characterized in that said membrane tank (10) assumes at least one safety condition where it is totally deflated and the wind generator (2) is completely lowered.

7. Platform according to claim 2, characterized in that said membrane tank (10) assumes at least one condition where it is totally inflated and the wind generator (2) is completely raised.

8. Platform according to claim 2, characterized in that said support element (9) of said membrane tank (10) can be positioned at different heights inside the central body (5) of the platform.

9. Platform according to claim 1, characterized in that said final section (4) comprises ribs (11) designed to engage inside suitable grooves (12) formed in the central body (5).

10. Platform according to claim 1, characterized in that said radial elements (6) have the same length and are equally spaced from each other and in that said platform is provided with suitable anchoring means
